(19) United States
(12) Patent Application Publication
(10) Pub. No.: US 2022/0385498 A1
(43) Pub. Date: Dec. 1, 2022

(54) ON-DEMAND AND SCALABLE TUNNEL MANAGEMENT IN A MULTI-CLOUD AND ON-PREMISES ENVIRONMENT

(71) Applicant: Cisco Technology, Inc., San Jose, CA (US)

(72) Inventors: Rajagopalan Janakiraman, Cupertino, CA (US); Arun Saha, Fremont, CA (US); Sivakumar Ganapathy, Fremont, CA (US); Jose Carlos Recuero Arias, Petaluma, CA (US); Sapan Shah, San Jose, CA (US); Shashank Chaturvedi, San Jose, CA (US)

(73) Assignee: Cisco Technology, Inc.

(21) Appl. No.: 17/335,887

(22) Filed: Jun. 1, 2021

(51) Int. Cl. H04L 12/46; H04L 12/24; H04L 29/08

(52) U.S. Cl. CPC H04L 12/4633; H04L 41/12; H04L 67/10; H04L 41/0893

(57) ABSTRACT

Techniques are described for dynamically establishing and scaling IPSec tunnels to connect hundreds of sites of a network by making use of the user intent of connecting certain applications for applying security policies and translating it dynamically based on the location and needs of the workloads to set up the network on demand. The techniques involve a tight loop between the network controller of a site (e.g., a cloud Application Policy Infrastructure Controller) and the inter-site or multi-cloud inter-connect controller, stitched through services that enable security and network automation at scale. In particular, to control the number of IPSec tunnels, IPSec tunnels are established only when required. Additionally, IPSec tunnels may be eliminated when no longer required. Thus, resources of a network may be used in a measured way that is necessary and sufficient to meet network traffic demand.

### TECHNICAL FIELD

The present disclosure relates generally to dynamically establishing and scaling IPSec tunnels to connect sites of a network.

### BACKGROUND

With the continued increase in the proliferation and use of devices with Internet accessibility, the demand for Internet services and content has similarly continued to increase. The providers of the Internet services and content continue to scale the computing resources required to service the growing number of user requests without falling short of user-performance expectations. For instance, providers typically utilize large and complex datacenters to manage the network and content demands from users. The datacenters generally comprise server farms that host workloads that support the services and content, and further include network devices such as switches and routers to route traffic through the datacenters and enforce security policies.

Generally, these networks of datacenters are one of two types: private networks owned by entities such as enterprises or organizations (e.g., on-premises networks); and public cloud networks owned by cloud providers that offer computing resources for purchase by users. Often, enterprises will own, maintain, and operate on-premises networks of computing resources to provide Internet services and/or content for users or customers. However, it can become difficult to satisfy the increasing demands for computing resources while maintaining acceptable performance for users. Accordingly, private entities often purchase or otherwise subscribe for use of computing resources and services from public cloud providers. For example, cloud providers can create virtual private clouds (also referred to herein as “private virtual networks”) on the public cloud and connect the virtual private cloud or network to the on-premises network in order to grow the available computing resources and capabilities of the enterprise. Thus, enterprises can interconnect their private or on-premises network of datacenters with a remote, cloud-based datacenter hosted on a public cloud, and thereby extend their private network.

Enterprises that manage on-premises networks of datacenters often isolate and segment their on-premises networks to improve scalability, resiliency, and security in their on-premises networks. To satisfy the entities' desire for isolation and segmentation, the endpoints in the on-premises networks can be grouped into endpoint groupings (EPGs) using, for example, isolated virtual networks that can be used to containerize the endpoints to allow for applying individualized routing models, policy models, etc., across the endpoints in the EPGs. Generally, each subnet in an EPG, or other virtual grouping of endpoints, is associated with a range of addresses that can be defined in routing tables used to control the routing for the subnet. Due to the large number of routing tables implemented to route traffic through the on-premises networks, the entities managing the on-premises networks utilize virtual routing and forwarding (VRF) technology.

In this multi-cloud, on-premises environment that spans geographies, the network is segregated into sites, where each cloud site spans multiple cloud regions of one cloud provider managed by a software-defined network (SDN) controller such as multi-cite controller, e.g., a cloud Application Policy Infrastructure Controller (APIC). The connectivity and segmentation for workloads communicating across these sites are managed by a second higher layer controller, such as a Multi-Site Orchestrator (MSO), which manages the inter-site policies of the cloud network(s) and on-prem network(s). If the network connecting the sites is the Internet, Internet Protocol (IP) Security (IPSec) tunnels are run between the regions of each of the sites to connect the workloads across the sites.

Since the IPSec tunnels are point to point, there are numerous challenges in a multi-cloud environment. For example, the end to end automation needs to work with multiple cloud providers (e.g., Amazon Web Services (AWS), Google Cloud, Microsoft Azure) and on-premises deployments. Discovering in cloud topology in terms of cloud regions and cloud routers (note: the number of cloud regions and the topology in each region can grow or shrink) may be be difficult. Detecting the (elastic) public IPs of the routers in the cloud for VPN termination may be difficult. Automating the pair-wise IPSec keys may be difficult. Programming the public IPs across the sites to set up the tunnels may be difficult. Scaling the tunnels (either up or down) based on the demand and the usage may be difficult. These are just a few examples of challenges in a multi-cloud environment.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIGS. 1A-1C schematically illustrate sites of a network with IPSec tunnels connecting endpoints, endpoint groups, and/or regions associated with the sites.

FIG. 2 illustrates a flow diagram of an example method for dynamically establishing IPSec tunnels between endpoints of endpoint groups.

FIG. 3 illustrates a flow diagram of another example method for dynamically establishing IPSec tunnels between endpoints of endpoint groups within regions of a network.

FIG. 4 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes techniques and architecture for dynamically establishing and scaling IPSec tunnels to connect hundreds of sites of a network by making use of the user intent of connecting certain applications for applying security policies and translating it dynamically based on the location and needs of the workloads to set up the network on demand. The techniques involve a tight loop between the network controller of a site (e.g., a cloud APIC) and the inter-site or multi-cloud inter-connect controller, stitched through services that enable security and network automation at scale. In particular, to control the number of IPSec tunnels, IPSec tunnels are established only when required. Additionally, IPSec tunnels may be eliminated when no longer required. Thus, resources of a network may be used in a measured way that is necessary and sufficient to meet network traffic demand.

For example, a method may include determining that a first endpoint group of a network is authorized to communicate with a second endpoint group of the network. The method may also include determining that at least one of (i) a first endpoint within the first endpoint group and (ii) a second endpoint within the second endpoint group wants to communicate with the other of (i) the first endpoint within the first endpoint group and (ii) the second endpoint within the second endpoint group. The method may further include based at least in part on determining that at least one of (i) a first endpoint within the first endpoint group and (ii) a second endpoint within the second endpoint group wants to communicate with the other of (i) the first endpoint within the first endpoint group and (ii) the second endpoint within the second endpoint group, establishing a tunnel between the first endpoint and the second endpoint.

Additionally, in configurations the method may include determining that at least one of (i) the first endpoint is no longer part of the first endpoint group or (ii) the second endpoint is no longer part of the second endpoint group. The method may also include based at least in part on determining that at least one of (i) the first endpoint is no longer part of the first endpoint group or (ii) the second endpoint is no longer part of the second endpoint group, eliminating the tunnel between the first endpoint and the second endpoint.

Also, in configurations, the method may include determining that the at least one of (i) the first endpoint within the first endpoint group and (ii) the second endpoint within the second endpoint group no longer wants to communicate with the other of (i) the first endpoint within the first endpoint group and (ii) the second endpoint within the second endpoint group. The method may include based at least in part on determining that the at least one of (i) the first endpoint within the first endpoint group and (ii) the second endpoint within the second endpoint group no longer wants to communicate with the other of (i) the first endpoint within the first endpoint group and (ii) the second endpoint within the second endpoint group, eliminating the tunnel between the first endpoint and the second endpoint.

Additionally, in configuration, the method may include determining regions of the network in which a first site of the network is active and regions of the network in which a second site of the network is active. The method may also include determining the regions in which the first endpoint group is deployed and determining the regions in which the second endpoint group is deployed. The method may further include based at least in part on (i) the regions in which the first endpoint group is deployed and (ii) the regions in which the second endpoint group is deployed, establishing region pairs, each region pair comprising a region in which the first endpoint group is deployed and a region in which the second endpoint group is deployed, each region in each region pair being active for communication with each other. The method may also include establishing a tunnel between the first endpoint group and the second endpoint group in each region pair.

In configurations, the techniques may provide a method that includes determining that a first endpoint group of a network is authorized to communicate with a second endpoint group of the network. The method may also include determining that (i) the first endpoint group includes a first endpoint and (ii) the second endpoint group includes a second point. The method may further include determining regions of the network in which a first site of the network is active and regions of the network in which a second site of the network is active. The method may additionally include determining the regions in which the first endpoint group is deployed and determining the regions in which the second endpoint group is deployed. The method may also include based at least in part on (i) the regions in which the first endpoint group is deployed and (ii) the regions in which the second endpoint group is deployed, establishing region pairs, each region pair comprising a region in which the first endpoint group is deployed and a region in which the second endpoint group is deployed, each region in each region pair being active for communication with each other. The method may further include establishing a tunnel between the first endpoint group and the second endpoint group in each region pair.

The techniques described herein may be performed by a system and/or device having non-transitory computer-readable media storing computer-executable instructions that, when executed by one or more processors, performs the method described above.

### Example Embodiments

As noted above, enterprises and other organizations may own, maintain, and operate on-premises networks of computing resources for users or customers, and also for supporting internal computing requirements for running their organizations. However, due to the difficulties in satisfying the increasing demands for computing resources while maintaining acceptable performance for users, these enterprises may otherwise subscribe for use of computing resources and services from public cloud providers. For example, cloud providers can create virtual private clouds on the public cloud and connect the virtual private cloud or network to the on-premises network in order to grow the available computing resources and capabilities of the enterprise. Thus, enterprises can interconnect their private or on-premises network of datacenters with a remote, cloud-based datacenter hosted on a public cloud, and thereby extend their private network.

In an intent-driven network architecture such as a cloud APIC, the end to end automation is driven based on a simple user intent of connecting two workloads. Generally, the policy and the overlay network automation are governed based on the user's intent of connecting two endpoint groups (EPGs) through a contract, where the contract allows the the two EPGs to communicate with each other. Each EPG is used to represent a “tier” of an application. In the event where the application or one of the tiers is deployed on multiple sites, one EPG can span multiple clouds or one of the EPGs in communication can belong to a different cloud/region/on-premises network. The intents of the EPG result in the programming of required security rules. The intents of the EPG also result in overlay routing (Border Gateway Protocol (BGP)-Ethernet Virtual Private Network (EVPN)) to leak the appropriate routes to other parts of the network. An “End Point Sync” service in a Multi-Site Orchestrator (MSO) programs the security rules of an EPG in the remote site(s).

With an Inter-site End-point Service, Cloud Application-Centric Infrastructure (ACI) also provides an automated way of discovering cloud routers in a region. Based on the user intent of using certain regions for inter-site connectivity, the fabric will connect to a cloud router in a remote region managed by another cloud APIC. The remote region can be in the same cloud provider or a different cloud provider. With an Inter-site Tunnel Service, a “Cloud Sync” service in MSO manages the connections. In collaboration with the cloud APIC, the Cloud Sync service allocates the unique IP addresses and subnets required for each of the tunnels. The Cloud Sync service generates the IPSec keys and programs the IPSec keys at both ends of the tunnel.

While the Inter-site Tunnel Service provides a fully automated tunnel network (e.g., the end to end automation work with multiple cloud providers and on-premises deployments; cloud topology may be discovered in terms of cloud regions and cloud routers, the (elastic) public IPs of the routers in the cloud for VPN termination may be detected, the pair-wise IPSec keys may be automated, the public IPs across the sites may be programmed to set up the tunnels, the Inter-site Tunnel Service may have problems with scaling the tunnels (either up or down) based on the demand and the usage. One reason is that the Inter-site Tunnel Service always uses a fixed number of routers from all the cloud regions and establishes a full mesh of tunnels among them. The tunnel establishment is not predicated on the user intents expressed through EPGs and contract.

Thus, in configurations, the user intent of EPG-EPG communication across sites of a network is used to program the IPSec underlay network. The Inter-site End-point Service, while capturing endpoint source-receiver pairs, also looks up a corresponding region/zone and provides a map of the source to destination regions. Also, the Inter-site End-point Service estimates the approximate bandwidth requirement based on the number of endpoints. This information may be used by the Inter-site Tunnel service before tunnel setup between any pair of routers across regions, leading to an on-demand scale. The Inter-site Tunnel Service and the Inter-site End-point Service are closely integrated to obtain an intent-based and demand-based (based on a number of endpoints) way of scaling IPSec tunnels. Thus, this integration auto-scales cloud IPSec tunnels based on application policy intent as well as real dynamics of applications actually being instantiated in a particular location.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

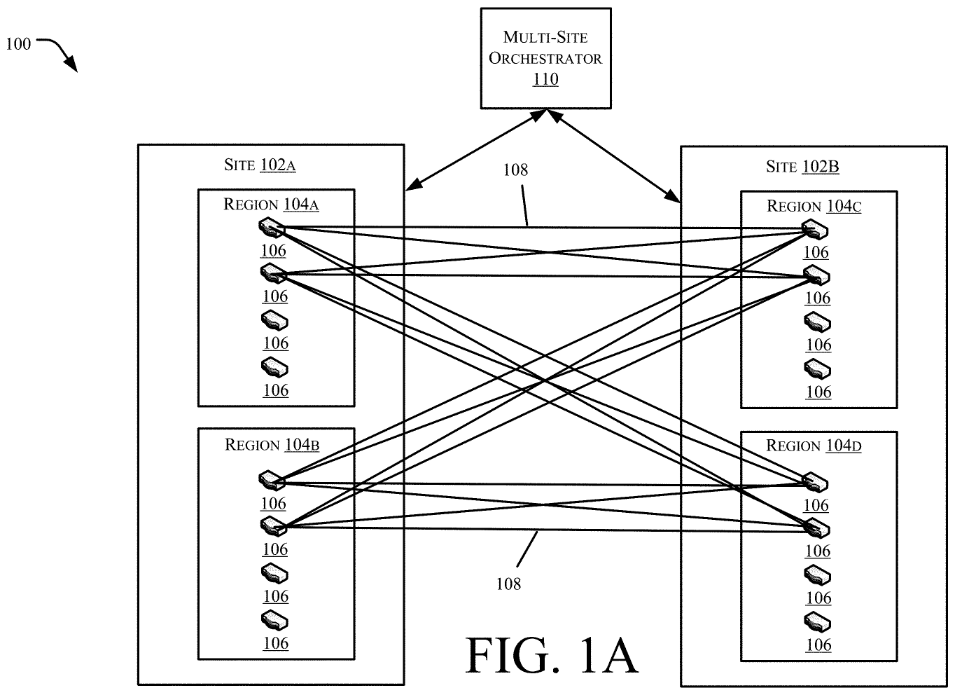

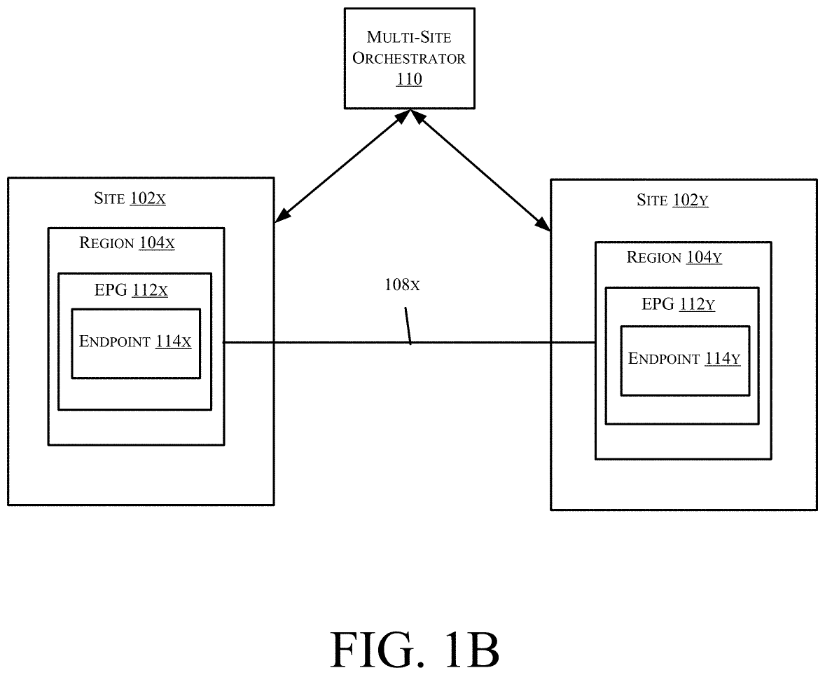

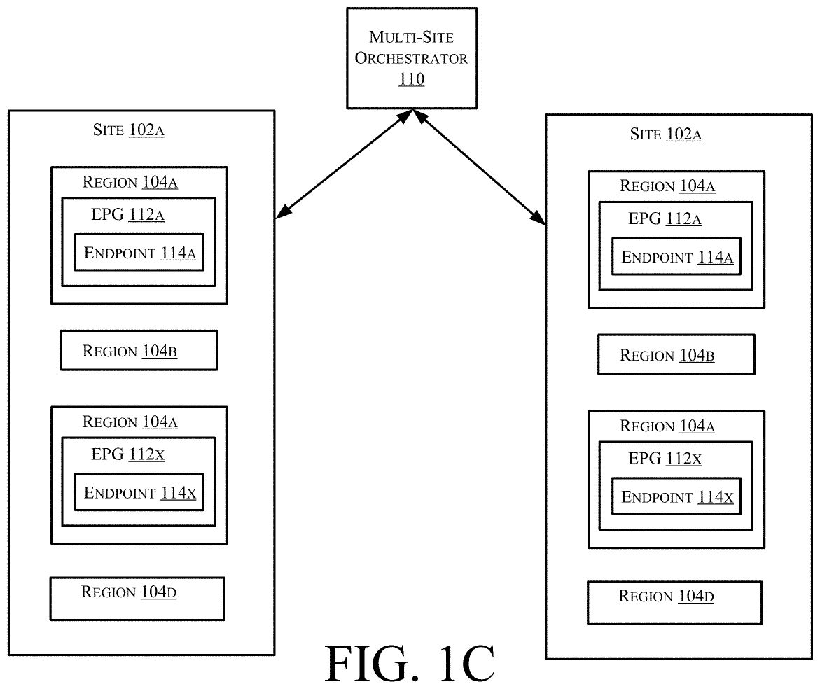

FIG. 1A schematically illustrates an example 100 of two sites 102a and 102b. The sites 102a and 102b may be implemented as part of a cloud network or an on-premises network. In FIG. 1A, site 102a, includes two regions 104a and 104b, while site 102b includes two regions 104c and 104d. Each region 104 includes four routers 106. In example 100a, the number of routers 106 per region enabled for site-to-site tunnels 108 is two. The site-to-site number of pairs is one. Thus, the number of tunnels per site-to-site pair is 16. This is determined based on (2 regions 104a, 104b in site 102a)×(2 enabled routers 106 per region 104)×(2 regions 104c, 104d in site 102b)×(2 enabled routers 106 per region 104), which is (2×2)×(2×2), which is 4×4. A Multi-Site Orchestrator (MSO) 110 is also included.

Consider in the example 100 of FIG. 1A if site 102a included four regions 104, site 102 included four regions 104, and each region 104 included four routers 106, with the number of routers 106 per region enabled for site-to-site tunnels 108 being two. Thus, the number of tunnels per site-to-site pair would be 64. This is determined based on (4 regions 104 in site 102a)×(2 enabled routers 106 per region 104)×(4 regions 104 in site 102b)×(2 enabled routers 106 per region 104), which is (4×2)×(4×2), which is 8×8.

Thus, it is clear from the above examples that the number of tunnels between a specific pair of sites 102 is variable. In one respect, it can be as low as 4 when the two sites have regions per site=1 and number of enabled routers per region=2. In another respect, it can be as high as 64 when the two sites have regions per site=4 and number of routers per region=2. Thus, the number of tunnels between a pair of sites 102 is variable.

With multiple sites and a full-mesh connection among them, the number of tunnels 108 depends on the tunnels-per-site-pair. For example, with four sites 102 and full mesh among the four sites 102, a low tunnel density results in 32 tunnels, whereas a high tunnel density results in 256 tunnels. In extreme cases, the Cloud Sync service establishes full-mesh tunnels between all routers 106 between a given pair of sites 102 (not just two routers 106, as in the examples 100a, 100b above). Then, at a particular router 106 at a specific site 102, the number of remote routers 106 for establishing tunnels 108 is Remote Routers=(number of remote sites 102)×(number of regions 104 per site)×(number of routers 106 per region 104). For a four-site topology (i.e., one local site 102 and three remote sites 102), four regions 104 per site 102, and four routers 106 per region 104, this results in, for a particular local router 106, remote routers 106=3×4×4=48. Thus, that particular local router 106 is one end of 48 tunnels 108. As the specific site 102 has 4×4=16 routers 106, the particular site 102 is one end of 16×48=2208 tunnels 108. Accordingly, there may be 2208 inter-site IPSec tunnels 108 originating or terminating at this specific site 102. This represents a large amount of resources for the IPSec tunnels 108 that may be unnecessary and/or unused.

With reference to FIG. 1B, to address the large amount of IPSec tunnels 108, in configurations, to control the number of IPSec tunnels 108, IPSec tunnels 108 are established only when required. Additionally, IPSec tunnels 108 may be eliminated when no longer required. In configurations, an IPSec tunnel 108x may be created from a particular region 104x in a particular local site 102x to a particular remote region 104y in a remote site 102y. The IPSec tunnel 108x may be created, in configurations, if and only if, both the following are true: there is a VRF stretched to that particular remote region 104y or there is a contract to an EPG 112y in that particular remote region 104y; and there is both a remote endpoint 114y (e.g., a router 106) in the EPG 112y that wants to communicate with a local endpoint 114x (e.g., another router 106) in an EPG 112x in the particular region 104x. This may be achieved with a collaboration between the End Point Sync service and the Cloud Sync service in the MSO. Additionally, each IPSec tunnel 108 needs two IP addresses, one for each end of the IPSec tunnel 108, in the same subnet. The minimum size subnet to allocate that is /30. In other words, each IPSec tunnel 108 needs a unique /30 subnet. This way 64 IPSec tunnels 108 need 64 subnets of size /30, which is equivalent to a /24 subnet. As the number of IPSec tunnels 108 grows, the number of unique IP addresses and the size of the subnet also grow together.

As an example, referring to FIG. 1C, in configurations, cloud APIC site 102a is deployed in regions 104a, 104b, 104c, and 104d, and cloud APIC site 102b is deployed in regions 104c, 104d, 104e, and 104f In previous approaches, as previously discussed, there would be IPSec tunnels 108 between all pairs of regions (e.g. {104a, 104c}, {104a, 104d}, . . . , {104d, 104f}), i.e., 16 region pairs. For this example, it is being ignored that each region 104 may have multiple routers 106. However, in this example, there is only one pair of EPGs between site 102a and 102b, EPG 112a and EPG 112b that are allowed to communicate as expressed through the contracts. Region-wise, EPG 112a is deployed in only two regions (104a and 104c) and EPG 112b is deployed in only two regions (104c and 104e). With this information, it is sufficient to have the inter-site IPSec tunnels 108 between site 102a to site 102b only for the following 4 region pairs: {104a, 104c}, {104a, 104e}, {104d, 104d} and {104c, 104e}. This results in a large reduction of resources to have the inter-site IPSec tunnels 104 only in 4 region pairs out of all possible 16 region pairs. Additionally, establishing the tunnels in the 4 region pairs is necessary only when there is at least one endpoint (for example endpoint 114a) discovered in EPG 112a and at least one endpoint (for example endpoint 114b) discovered in EPG 112b.

In configurations, the End Point Sync service of an MSO maintains the following tables: an Inter-site Contracts table; an Endpoint table; an Inter-site Contract Activeness table; and a Region Pair Activeness table.

The Inter-site Contracts table maintains the association from an EPG 112 to a contract. (note: this is based on a management plane configuration only.) Table 1 below illustrates an example of an Inter-site Contracts Table for the present example.

TABLE 1

| EPG ID | Contract ID |
|---|---|
| EPG 112a | C1 |
| EPG 112b | C1 |
| . . . | . . . |

The Endpoint table following maintains the discovered endpoints. Table 2 below illustrates an example of an Endpoint table.

TABLE 2

| EPG ID | Endpoint ID |
|---|---|
| EPG 112a | Endpoint 114a |
| EPG 112a | Endpoint 114c |
| EPG 112b | Endpoint 114b |
| . . . | . . . |

The Inter-site Contract Activeness table maintains the activeness (active vs. inactive) of a contract and the corresponding list of necessary region pairs. A contract is active if and only if both its constituent EPGS 112 have at least one endpoint 114. Table 3 below illustrates an example of an Inter-site Contract Activeness table.

TABLE 3

| | | | | Active (True if |
|---|---|---|---|---|
| | | | | both EPGs |
| | | EPG ID | Region Pair | have at least |
| Contract ID | EPG ID (lower) | (higher) | List | one endpoint) |
| C1 | EPG 112a | EPG 112b | {104a, 104c}, | True |
| | | | {104a, 104e}, | |
| | | | {104d, 104d} | |
| | | | and {104c, | |
| | | | 104e} | |
| . . . | . . . | . . . | . . . | . . . |

The Region Pair Activeness table tracks the number of active contracts between a region pair. Table 4 below illustrates an example of a Region Pair Activeness table. Whenever there is a change in the Inter-Site Contract Activeness table (Table 3), the Region Pair Activeness table (Table 4) is also updated. For brevity, the present example ignores the site ID. In reality, when more than two sites are involved, then the Region ID should be accompanied by the Site ID.

TABLE 4

| | | Active Contract Count |
|---|---|---|
| | | (Number of active |
| | | contracts between the |
| | | region pair, a reference |
| Region ID (lower) | Region ID (higher) | count) |
| Region 104a | Region 104c | 1 |
| Region 104a | Region 104e | 1 |
| Region 104c | Region 104c | 1 |
| Region 104c | Region 104e | 1 |
| . . . | . . . | . . . |

In configurations, The Cloud Sync service of the MSO operates based on the Region Pair Activeness table (table 4) as follows: if a region pair is active (i.e., Active Contract Count is greater than zero), then IPSec tunnels 108 are established (or retained) between that region pair; and if a region pair is inactive (i.e., Active Contract Count is equal to zero), then IPSec tunnels are eliminated or removed (or not established) between that region pair. In configurations, in order to dampen the potential fluctuations of establishing and eliminating IPSec tunnels 108, a “hold timer” may be implemented. Once a particular IPSec tunnel 108 is not necessary, the particular IPSec tunnel 108 may be retained for a “hold timer” predetermined amount of time before actually being eliminated.

Thus, the techniques described herein closely integrate the Inter-site Tunnel service and the Inter-site Endpoint service of the MSO to obtain an intent-based and demand-based (based on the number of endpoints) way of scaling IPSec tunnels 108. The techniques enable a cloud APIC fabric to retain only those IPSec tunnels 108 that are necessary and sufficient. Having the “necessary” IPSec tunnels 108 help ensure that the underlying network is connected as required. Having only the “sufficient” IPSec tunnels 108 helps ensure that there are no extra IPSec tunnels 108 established but not being used. Avoiding extra IPSec tunnels 108 avoids wasting resources compared to the previous pre-provisioning approach of establishing IPSec tunnels 108. Thus, based on the techniques described herein, the establishment of the IPSec tunnels 108 are fully on-demand and purely intent-driven.

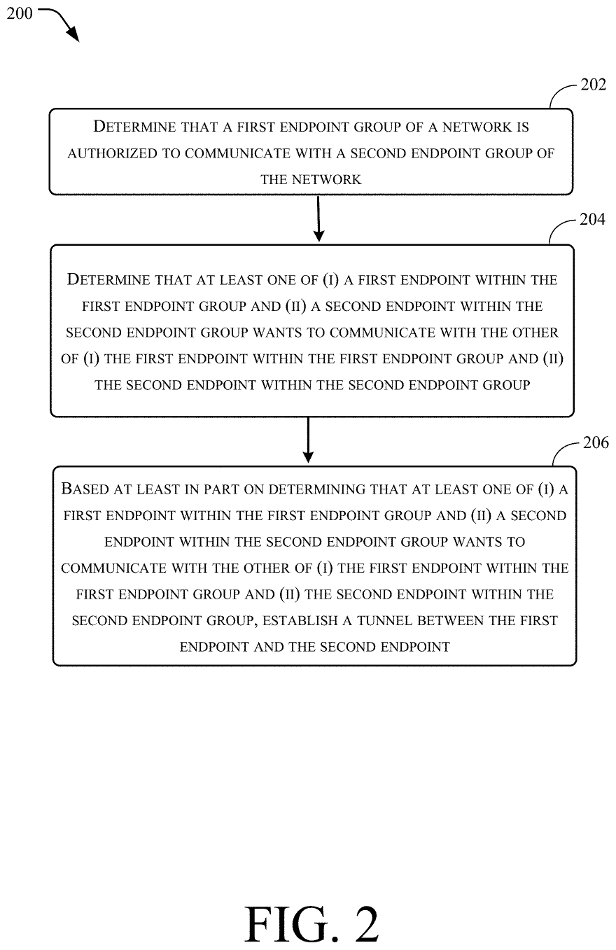

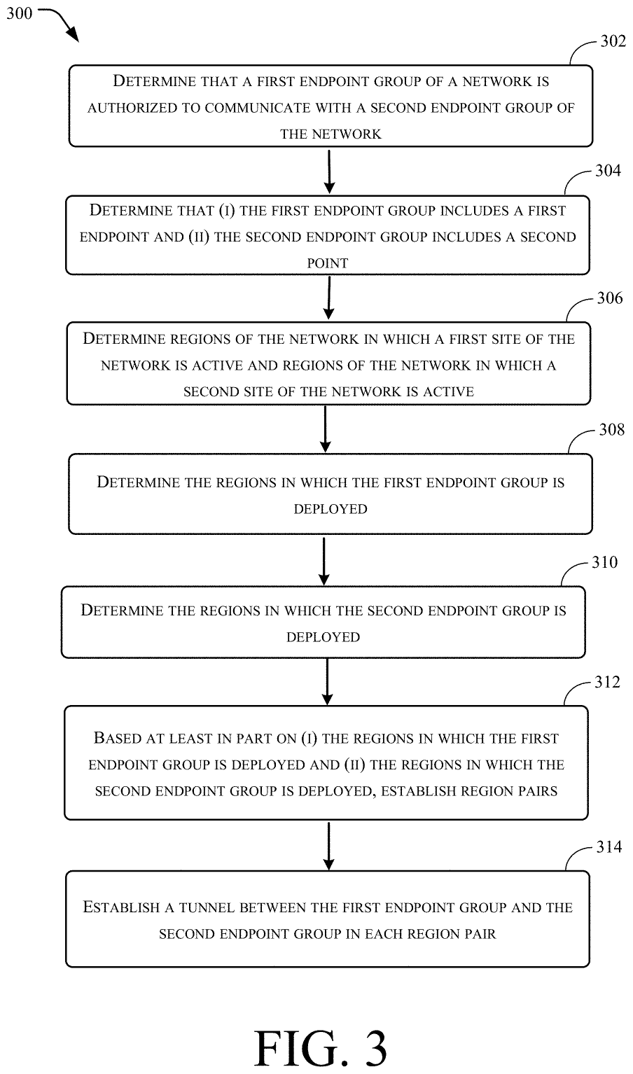

FIGS. 2 and 3 illustrate flow diagrams of example methods 200 and 300 and illustrate aspects of the functions performed at least partly by a Multi-Site Orchestrator (MSO), e.g., MSO 110, of a network as described with respect to FIGS. 1A-1C. The logical operations described herein with respect to FIGS. 2 and 3 may be implemented (1) as a sequence of computer-implemented acts or program modules running on a computing system, and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIGS. 2 and 3 and described herein. These operations can also be performed in parallel, or in a different order than those described herein. Some or all of these operations can also be performed by components other than those specifically identified. Although the techniques described in this disclosure are with reference to specific components, in other examples, the techniques may be implemented by less components, more components, different components, or any configuration of components.

FIG. 2 illustrates a flow diagram of an example method 200 for dynamically establishing IPSec tunnels, e.g., IPSec tunnels 108, between endpoints, e.g., endpoints 114, of endpoint groups, e.g., endpoint groups 112. In some examples, the method 200 may be performed by a system comprising one or more processors and one or more non-transitory computer-readable media storing computer-executable instructions that, when executed by the one or more processors, cause the one or more processors to perform the method 200.

At 202, it is determined that a first endpoint group of a network is authorized to communicate with a second endpoint group of the network. At 204, it determined that at least one of (i) a first endpoint within the first endpoint group and (ii) a second endpoint within the second endpoint group wants to communicate with the other of (i) the first endpoint within the first endpoint group and (ii) the second endpoint within the second endpoint group. At 206, based at least in part on determining that at least one of (i) a first endpoint within the first endpoint group and (ii) a second endpoint within the second endpoint group wants to communicate with the other of (i) the first endpoint within the first endpoint group and (ii) the second endpoint within the second endpoint group, a tunnel is established between the first endpoint and the second endpoint.

FIG. 3 illustrates a flow diagram of another example method 300 for dynamically establishing IPSec tunnels, e.g., IPSec tunnels 108, between endpoints, e.g., endpoints 114, of endpoint groups, e.g., endpoint groups 112, within regions, e.g., regions 104, of a network. In some examples, the method 300 may be performed by a system comprising one or more processors and one or more non-transitory computer-readable media storing computer-executable instructions that, when executed by the one or more processors, cause the one or more processors to perform the method 300.

At 302, it is determined that a first endpoint group of a network is authorized to communicate with a second endpoint group of the network. At 304, it is determined that (i) the first endpoint group includes a first endpoint and (ii) the second endpoint group includes a second point. At 306, regions of the network in which a first site of the network is active and regions of the network in which a second site of the network is active are determined.

At 308, the regions in which the first endpoint group is deployed are determined. At 310, the regions in which the second endpoint group is deployed are determined. At 312, based at least in part on (i) the regions in which the first endpoint group is deployed and (ii) the regions in which the second endpoint group is deployed, region pairs are established. Each region pair comprises a region in which the first endpoint group is deployed and a region in which the second endpoint group is deployed and each region in each region pair is active for communication with each other. At 314, a tunnel is established between the first endpoint group and the second endpoint group in each region pair.

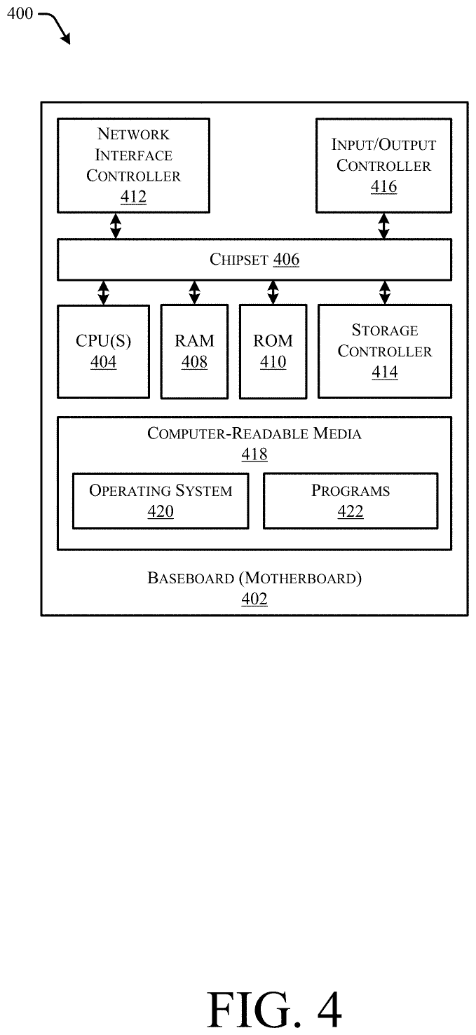

FIG. 4 shows an example computer architecture for a computing device 402 capable of executing program components for implementing the functionality described above. In configurations, the computing device 402 may be used to implement the MSO 110 for example. The computer architecture shown in FIG. 4 illustrates a conventional server computer, workstation, desktop computer, laptop, tablet, network appliance, e-reader, smartphone, or other computing device, and can be utilized to execute any of the software components presented herein. The computing device 402 may, in some examples, correspond to a physical devices or resources described herein.

The computing device 402 includes a baseboard 402, or “motherboard,” which is a printed circuit board to which a multitude of components or devices can be connected by way of a system bus or other electrical communication paths. In one illustrative configuration, one or more central processing units (“CPUs”) 404 operate in conjunction with a chipset 406. The CPUs 404 can be standard programmable processors that perform arithmetic and logical operations necessary for the operation of the computing device 402.

The CPUs 404 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 406 provides an interface between the CPUs 404 and the remainder of the components and devices on the baseboard 402. The chipset 406 can provide an interface to a RAM 408, used as the main memory in the computing device 402. The chipset 406 can further provide an interface to a computer-readable storage medium such as a read-only memory (“ROM”) 410 or non-volatile RAM (“NVRAM”) for storing basic routines that help to startup the computing device 402 and to transfer information between the various components and devices. The ROM 410 or NVRAM can also store other software components necessary for the operation of the computing device 402 in accordance with the configurations described herein.

The computing device 402 can operate in a networked environment using logical connections to remote computing devices and computer systems through a network, such as the network 408. The chipset 406 can include functionality for providing network connectivity through a NIC 412, such as a gigabit Ethernet adapter. The NIC 412 is capable of connecting the computing device 402 to other computing devices over the network 408. It should be appreciated that multiple NICs 412 can be present in the computing device 402, connecting the computer to other types of networks and remote computer systems.

The computing device 402 can be connected to a storage device 418 that provides non-volatile storage for the computer. The storage device 418 can store an operating system 420, programs 422, and data, which have been described in greater detail herein. The storage device 418 can be connected to the computing device 402 through a storage controller 414 connected to the chipset 406. The storage device 418 can consist of one or more physical storage units. The storage controller 414 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 402 can store data on the storage device 418 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 418 is characterized as primary or secondary storage, and the like.

For example, the computing device 402 can store information to the storage device 418 by issuing instructions through the storage controller 414 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 402 can further read information from the storage device 418 by detecting the physical states or characteristics of one or more particular locations within the physical storage units.

In addition to the mass storage device 418 described above, the computing device 402 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 402. In some examples, the operations performed by the cloud computing network, and or any components included therein, may be supported by one or more devices similar to computing device 402. Stated otherwise, some or all of the operations described herein may be performed by one or more computing devices 402 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 418 can store an operating system 420 utilized to control the operation of the computing device 402. According to one embodiment, the operating system comprises the LINUX operating system. According to another embodiment, the operating system comprises the WINDOWS® SERVER operating system from MICROSOFT Corporation of Redmond, Wash. According to further embodiments, the operating system can comprise the UNIX operating system or one of its variants. It should be appreciated that other operating systems can also be utilized. The storage device 418 can store other system or application programs and data utilized by the computing device 402.

In one embodiment, the storage device 418 or other computer-readable storage media is encoded with computer-executable instructions which, when loaded into the computing device 402, transform the computer from a general-purpose computing system into a special-purpose computer capable of implementing the embodiments described herein. These computer-executable instructions transform the computing device 402 by specifying how the CPUs 404 transition between states, as described above. According to one embodiment, the computing device 402 has access to computer-readable storage media storing computer-executable instructions which, when executed by the computing device 402, perform the various processes described above with regard to FIGS. 1A-1C, 2, and 3. The computing device 402 can also include computer-readable storage media having instructions stored thereupon for performing any of the other computer-implemented operations described herein.

The computing device 402 can also include one or more input/output controllers 416 for receiving and processing input from a number of input devices, such as a keyboard, a mouse, a touchpad, a touch screen, an electronic stylus, or other type of input device. Similarly, an input/output controller 416 can provide output to a display, such as a computer monitor, a flat-panel display, a digital projector, a printer, or other type of output device. It will be appreciated that the computing device 402 might not include all of the components shown in FIG. 4, can include other components that are not explicitly shown in FIG. 4, or might utilize an architecture completely different than that shown in FIG. 4.

The computing device 402 may support a virtualization layer, such as one or more virtual resources executing on the computing device 402. In some examples, the virtualization layer may be supported by a hypervisor that provides one or more virtual machines running on the computing device 402 to perform functions described herein. The virtualization layer may generally support a virtual resource that performs at least portions of the techniques described herein.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

1. A computer-implemented method comprising:
determining that a first endpoint group of a network is authorized to communicate with a second endpoint group of the network;
determining that at least one of (i) a first endpoint within the first endpoint group and (ii) a second endpoint within the second endpoint group wants to communicate with the other of (i) the first endpoint within the first endpoint group and (ii) the second endpoint within the second endpoint group;
based at least in part on determining that at least one of (i) a first endpoint within the first endpoint group and (ii) a second endpoint within the second endpoint group wants to communicate with the other of (i) the first endpoint within the first endpoint group and (ii) the second endpoint within the second endpoint group, establishing a tunnel between the first endpoint and the second endpoint;
determining that the tunnel between the first endpoint and the second endpoint should be eliminated;
after determining that the tunnel between the first endpoint and the second endpoint should be eliminated, automatically waiting a predetermined amount of time; and
after waiting the predetermined amount of time, eliminating the tunnel between the first endpoint and the second endpoint.

2. The computer-implemented method of claim 1, wherein determining that the tunnel between the first endpoint and the second endpoint should be eliminated comprises:
determining that at least one of (i) the first endpoint is no longer part of the first endpoint group or (ii) the second endpoint is no longer part of the second endpoint group; and
based at least in part on determining that at least one of (i) the first endpoint is no longer part of the first endpoint group or (ii) the second endpoint is no longer part of the second endpoint group, eliminating the tunnel between the first endpoint and the second endpoint.

3. The computer-implemented method of claim 1, wherein determining that the tunnel between the first endpoint and the second endpoint should be eliminated comprises:
determining that the at least one of (i) the first endpoint within the first endpoint group and (ii) the second endpoint within the second endpoint group no longer wants to communicate with the other of (i) the first endpoint within the first endpoint group and (ii) the second endpoint within the second endpoint group; and
based at least in part on determining that the at least one of (i) the first endpoint within the first endpoint group and (ii) the second endpoint within the second endpoint group no longer wants to communicate with the other of (i) the first endpoint within the first endpoint group and (ii) the second endpoint within the second endpoint group, eliminating the tunnel between the first endpoint and the second endpoint.

4. (canceled)

5. The computer-implemented method of claim 1, further comprising:
determining regions of the network in which a first site of the network is active and regions of the network in which a second site of the network is active;
determining the regions in which the first endpoint group is deployed;
determining the regions in which the second endpoint group is deployed;
based at least in part on (i) the regions in which the first endpoint group is deployed and (ii) the regions in which the second endpoint group is deployed, establishing region pairs, each region pair comprising a region in which the first endpoint group is deployed and a region in which the second endpoint group is deployed, each region in each region pair being active for communication with each other; and
establishing a tunnel between the first endpoint group and the second endpoint group in each region pair.

6. The computer-implemented method of claim 5, further comprising:
determining that regions within a region pair are no longer active for communication with each other; and
based at least in part on determining that regions within the region pair are no longer active for communication with each other, eliminating the tunnel between the regions of the region pair.

7. The computer-implemented method of claim 6, further comprising:
prior to eliminating the tunnel between the regions of the region pair, waiting a predetermined amount of time.

8. The computer-implemented method of claim 5, further comprising:
determining that the first endpoint group is no longer authorized to communicate with the second endpoint group; and
based at least in part on determining that the first endpoint group is no longer authorized to communicate with the second endpoint group, eliminating all tunnels between the first endpoint group and the second endpoint group between each region in each region pair.

9. An apparatus comprising:
one or more processors; and
one or more non-transitory computer-readable media storing computer-executable instructions that, when executed by the one or more processors, cause the one or more processors to perform actions comprising:
determining that a first endpoint group of a network is authorized to communicate with a second endpoint group of the network;
determining that at least one of (i) a first endpoint within the first endpoint group and (ii) a second endpoint within the second endpoint group wants to communicate with the other of (i) the first endpoint within the first endpoint group and (ii) the second endpoint within the second endpoint group;
based at least in part on determining that at least one of (i) a first endpoint within the first endpoint group and (ii) a second endpoint within the second endpoint group wants to communicate with the other of (i) the first endpoint within the first endpoint group and (ii) the second endpoint within the second endpoint group, establishing a tunnel between the first endpoint and the second endpoint;
determining that the tunnel between the first endpoint and the second endpoint should be eliminated;
after determining that the tunnel between the first endpoint and the second endpoint should be eliminated, automatically waiting a predetermined amount of time; and
after waiting the predetermined amount of time, eliminating the tunnel between the first endpoint and the second endpoint.

10. The apparatus of claim 9, wherein determining that the tunnel between the first endpoint and the second endpoint should be eliminated comprises:
determining that at least one of (i) the first endpoint is no longer part of the first endpoint group or (ii) the second endpoint is no longer part of the second endpoint group; and
based at least in part on determining that at least one of (i) the first endpoint is no longer part of the first endpoint group or (ii) the second endpoint is no longer part of the second endpoint group, eliminating the tunnel between the first endpoint and the second endpoint.

11. The apparatus of claim 9, wherein determining that the tunnel between the first endpoint and the second endpoint should be eliminated comprises:
determining that the at least one of (i) the first endpoint within the first endpoint group and (ii) the second endpoint within the second endpoint group no longer wants to communicate with the other of (i) the first endpoint within the first endpoint group and (ii) the second endpoint within the second endpoint group; and
based at least in part on determining that the at least one of (i) the first endpoint within the first endpoint group and (ii) the second endpoint within the second endpoint group no longer wants to communicate with the other of (i) the first endpoint within the first endpoint group and (ii) the second endpoint within the second endpoint group, eliminating the tunnel between the first endpoint and the second endpoint.

12. (canceled)

13. The apparatus of claim 9, wherein the actions further comprise:
determining regions of the network in which a first site of the network is active and regions of the network in which a second site of the network is active;
determining the regions in which the first endpoint group is deployed;
determining the regions in which the second endpoint group is deployed;
based at least in part on (i) the regions in which the first endpoint group is deployed and (ii) the regions in which the second endpoint group is deployed, establishing region pairs, each region pair comprising a region in which the first endpoint group is deployed and a region in which the second endpoint group is deployed, each region in each region pair being active for communication with each other; and
establishing a tunnel between the first endpoint group and the second endpoint group in each region pair.

14. The apparatus of claim 13, wherein the actions further comprise:
determining that regions within a region pair are no longer active for communication with each other; and
based at least in part on determining that regions within the region pair are no longer active for communication with each other, eliminating the tunnel between the regions of the region pair.

15. The apparatus of claim 14, wherein the actions further comprise:
prior to eliminating the tunnel between the regions of the region pair, waiting a predetermined amount of time.

16. The apparatus of claim 13, wherein the actions further comprise:
determining that the first endpoint group is no longer authorized to communicate with the second endpoint group; and
based at least in part on determining that the first endpoint group is no longer authorized to communicate with the second endpoint group, eliminating all tunnels between the first endpoint group and the second endpoint group between each region in each region pair.

17.-20. (canceled)

21. One or more non-transitory computer-readable media storing computer-executable instructions that, when executed by one or more processors, cause the one or more processors to perform actions comprising:
determining that a first endpoint group of a network is authorized to communicate with a second endpoint group of the network;
determining that at least one of (i) a first endpoint within the first endpoint group and (ii) a second endpoint within the second endpoint group wants to communicate with the other of (i) the first endpoint within the first endpoint group and (ii) the second endpoint within the second endpoint group;
based at least in part on determining that at least one of (i) a first endpoint within the first endpoint group and (ii) a second endpoint within the second endpoint group wants to communicate with the other of (i) the first endpoint within the first endpoint group and (ii) the second endpoint within the second endpoint group, establishing a tunnel between the first endpoint and the second endpoint;
determining that the tunnel between the first endpoint and the second endpoint should be eliminated;
after determining that the tunnel between the first endpoint and the second endpoint should be eliminated, automatically waiting a predetermined amount of time; and
after waiting the predetermined amount of time, eliminating the tunnel between the first endpoint and the second endpoint.

22. The one or more non-transitory computer-readable media of claim 21, wherein determining that the tunnel between the first endpoint and the second endpoint should be eliminated comprises:
determining that at least one of (i) the first endpoint is no longer part of the first endpoint group or (ii) the second endpoint is no longer part of the second endpoint group; and
based at least in part on determining that at least one of (i) the first endpoint is no longer part of the first endpoint group or (ii) the second endpoint is no longer part of the second endpoint group, eliminating the tunnel between the first endpoint and the second endpoint.

23. The one or more non-transitory computer-readable media of claim 21, wherein determining that the tunnel between the first endpoint and the second endpoint should be eliminated comprises:
determining that the at least one of (i) the first endpoint within the first endpoint group and (ii) the second endpoint within the second endpoint group no longer wants to communicate with the other of (i) the first endpoint within the first endpoint group and (ii) the second endpoint within the second endpoint group; and
based at least in part on determining that the at least one of (i) the first endpoint within the first endpoint group and (ii) the second endpoint within the second endpoint group no longer wants to communicate with the other of (i) the first endpoint within the first endpoint group and (ii) the second endpoint within the second endpoint group, eliminating the tunnel between the first endpoint and the second endpoint.

24. The one or more non-transitory computer-readable media of claim 21, wherein the actions further comprise:
determining regions of the network in which a first site of the network is active and regions of the network in which a second site of the network is active;
determining the regions in which the first endpoint group is deployed;
determining the regions in which the second endpoint group is deployed;
based at least in part on (i) the regions in which the first endpoint group is deployed and (ii) the regions in which the second endpoint group is deployed, establishing region pairs, each region pair comprising a region in which the first endpoint group is deployed and a region in which the second endpoint group is deployed, each region in each region pair being active for communication with each other; and
establishing a tunnel between the first endpoint group and the second endpoint group in each region pair.
